(19) United States
(12) Patent Application Publication
(10) Pub. No.: US 2008/0277856 A1
(43) Pub. Date: Nov. 13, 2008

(54) UNIVERSAL CHOPPING BOARD SYSTEM

(76) Inventors: Elizabeth Wen Tortora, Syosset, NY (US); Tamara Monosoft, Walnut Crcek, CA (US)

Correspondence Address: WEST & ASSOCIATES, A PC, 2815 MITCHELL DRIVE, SUITE 209, WALNUT CREEK, CA, 94598, US

(21) Appl. No.: 12/119,431

(22) Filed: May 12, 2008

Related U.S. Application Data
(60) Provisional application No. 60/917,632, filed on May 11, 2007.
(60) Provisional application No. 60/917,650, filed on May 12, 2007.

(51) Int. Cl. B23Q 3/00

(52) U.S. Cl. 269/289 R

(57) ABSTRACT

A universal cutting board system comprising a cutting surface and a drawer, wherein said drawer is coupled with a first side of said cutting surface such that said drawer can be transitioned from an open state, a closed state and a removed state without substantial physical movement of said cutting surface.

### CLAIM OF PRIORITY

This application claims the benefit of priority of U.S. Provisional patent Application No. 60/917,632, filed May 11, 2007, the complete contents of which is hereby incorporated herein by referenced, and U.S. Provisional patent application No. 60/917,650, filed May 12, 2007, the complete contents of which is hereby incorporated herein by reference.

### BACKGROUND

1. Field of the Invention

The invention relates generally to kitchen utensils and more specifically to cutting boards.

2. Background

When preparing items for cooking or just generally during food preparation, frequently individuals need to cut more that one item and will need to transfer the food from the cutting board to either a serving dish or another container, either for cooking or use. While numerous flexible cutting boards exist that allow a user to funnel and “pour” the cut items into a dish, nothing is currently on the market which allows a user to transfer the cut items to a container without physically elevating the cutting board in some manner.

What is needed is a universal cutting board system which allows a user to access multiple surfaces and allows a user to transfer the cut articles into a container without requiring physical movement of the cutting board.

### SUMMARY

A universal cutting board system comprising a cutting surface and a drawer, wherein said drawer is coupled with a first side of said cutting surface such that said drawer can be transitioned from an open state, a closed state and a removed state without substantial physical movement of said cutting surface.

### BRIEF DESCRIPTION OF THE DRAWINGS

FIGS. 1a-1e depict embodiments of the universal cutting board system.

FIGS. 2-3E depict various alternate embodiments of the cutting board system depicted in FIG. 1.

FIG. 4 depicts an alternate embodiment of the cutting board system.

### DETAILED DESCRIPTION

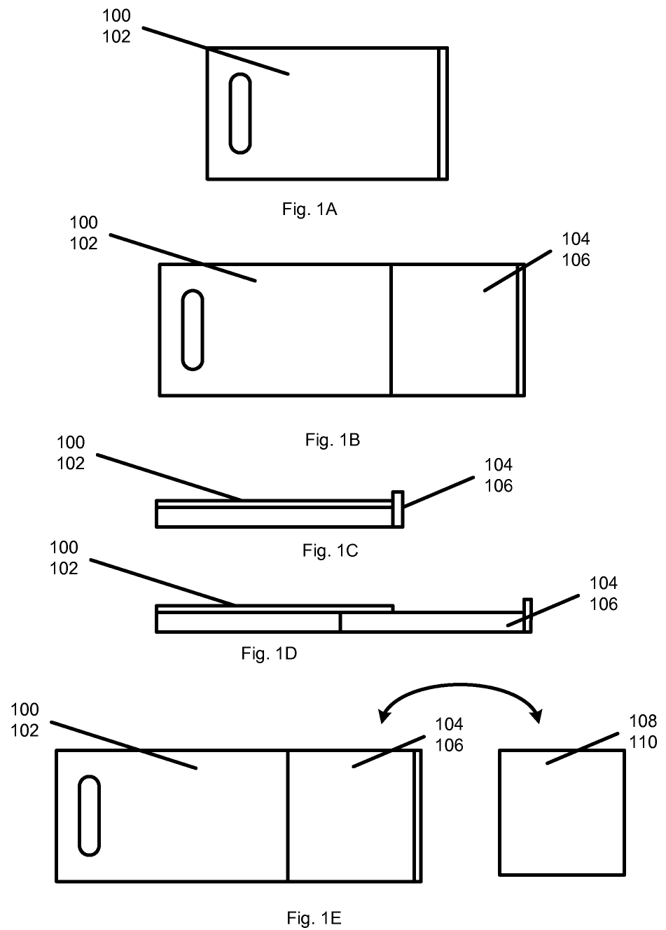

With reference to FIGS. 1a-1e, the universal cutting board system 100 is a chopping board 102 that allows chopped food or scraps to be scraped off the board without having to lift the board up. The food and/or scrap is thrown into the drawer 104 or into a tray 106 which can optionally be placed into the drawer 104. The tray 106 or drawer 104 can then be taken out and replaced by a clean tray 110 or drawer 108. This allows food preparation to be clean and convenient.

In the embodiment depicted in FIGS. 1a-1e, the chopping board 102 has a predetermined thickness and can be hollowed and/or elevated to allows space for a drawer 104 to be removeably inserted below the cutting board 102. The drawer 104 is capable of holding one or more containers 106 and the container(s) 106 can be comprised of any known and/or convenient material, as can the cutting surface 102. In operation, during, before or after cutting, the drawer 104 can be withdrawn from the closed position and the cut food and/or scraps can be scraped off the board into the desired container(s) 106 and/or the drawer 104. The container(s) 106 and/or the drawer 104 can then be replaced and the user can continue with food preparation.

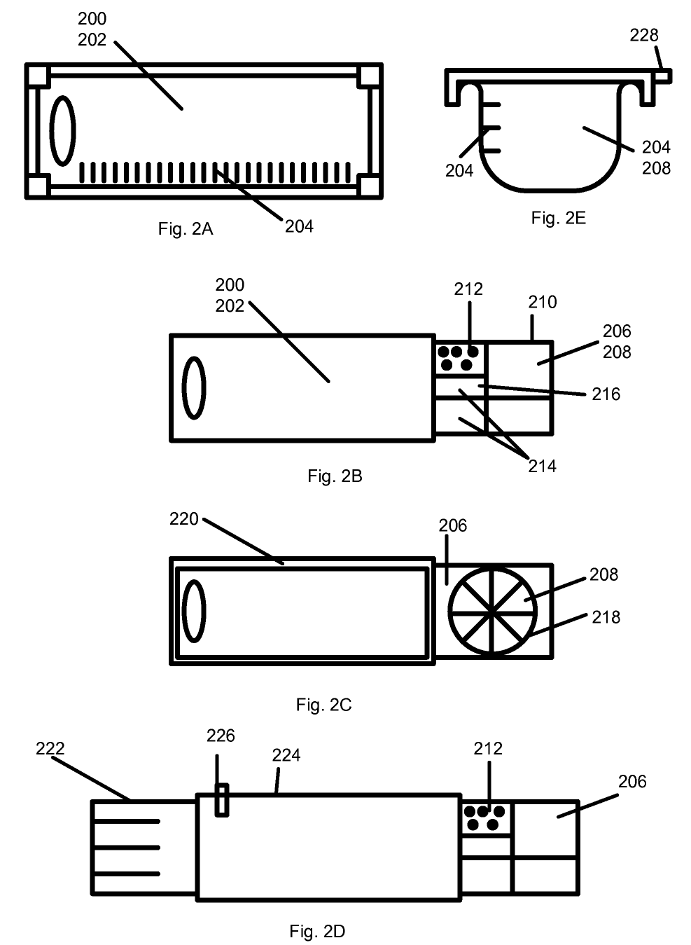

FIGS. 2A-2E depict alternate embodiments of the universal cutting board system depicted in FIGS. 1a-1e. In FIG. 2a, the cutting board 200 can be configured such that the cutting surface 202 can be changed as desired and can be changed with various colored boards and/or reversed as desired by the user. Additionally, in some embodiments the cutting surface 202 can include dimension markings 204 such that a user can accurately measure food and/or accurately cut food. In still further alternate embodiments, the cutting board 200 and/or drawer 206 and/or containers 208 can be comprised of a material 210 impregnated and or bonded with an anti-bacterial substance, such as an N-alkylated poly(4-vinylpyridine) group substance, tea tree oil and/or any other known and/or convenient material.

FIG. 2b depicts an alternate embodiment in which multiple containers 208 can be included in the drawer 206 and the containers 208 can have differing sizes and shapes. In some embodiments one or more of the containers 212 can be perforated to allow contents to be strained. Moreover, in some embodiments the under portion 214 of the drawer can be at least partially removable and/or not present and the containers can be supported on side rails or by any other known and or convenient mechanism. Thus, when food is strained in a straining container, the liquid will not be contained by the drawer, but will pass directly through to either a sink or a container below the straining container. Additionally, in some embodiments more than one drawer 216 can be included such that liquid could be captured in the lower layer and the solid contents could be strained/captured in the upper drawer's container(s) 212.

FIG. 2C depicts an alternate embodiment in which the containers 208 are positioned on a carousel 218 which can be rotated. Additionally, in some embodiments the cutting surface can contain guides 220 such that liquid can be directed toward the perimeter of the cutting surface and ultimately delivered to a desired location such as the drawer 206 and/or any other desired location.

FIG. 2D an alternate embodiment which includes a second drawer 222. In some embodiments the second drawer 222 (and/or more drawers) can be on a different level than the first drawer 206 and/or the same level. In some embodiments the drawer 222 can located in opposition to the first drawer 206. However, in alternate embodiments the drawers 206 and 222 (two or more) can be configured in any convenient geometric relationship.

In some embodiments any one or more of the drawers 222 can include divisions/locations for cutlery, utensils and/or knives. Moreover, in some embodiments the cutting surface 224 can be coupled with a blade sharpener 226. In alternate embodiments, the blade sharpener 226 can be coupled with the system in any known convenient location and/or in any known and/or convenient manner.

As depicted in FIG. 2E, in some embodiments the containers 208 in the drawer 206 can have lids 228 adapted to selectively seal the containers in a closed position. In some embodiments the containers can include measurement markings 204.

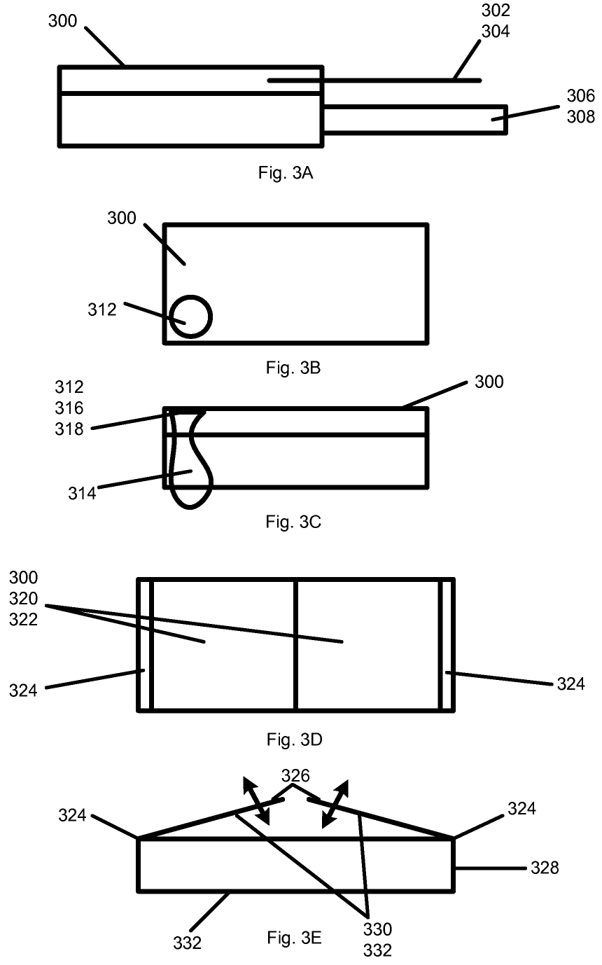

FIG. 3A depicts an alternate embodiment which comprises an additional surface 302. In some embodiments the second surface can be a secondary cutting surface 302 and/or can be a filtering surface 304. Thus, in some embodiment if the user is attempting to collect liquid in the container(s)/drawer(s) 306/308 below user can strain the item through the filter 304 and collect liquid in the container 306 below. Alternately, the user can insert an additional cutting surface 302 which will allow a user to expand the cutting surface 300 available.

FIG. 3B depicts an alternate embodiment in which an aperture 312 is located in the cutting surface 300. The aperture 312 can be used to deliver items to the drawer(s)/container(s) 306/308 below and/or can be coupled with a flexible container 314 located below (FIG. 3C). In some embodiments the flexible container 314 can be held in place by a retainer element 316 that can engage the cutting surface 300 and/or selectively engage the system in any known and/or convenient manner. In some embodiments, the system can include an insert 318 adapted to mate with the aperture 312 in the cutting surface 300 and provide the user with a substantially uniform cutting surface without the aperture 312.

FIGS. 3D and 3E depict an alternate embodiment in which the cutting surface 300 can be used in a plurality of positions to provide a user with multiple cutting surfaces 320 and/or alternate cutting surfaces 322 without having to replace the cutting surface 300. In the embodiment depicted in FIGS. 3D and 3E, the cutting surface 300 can be hinged 324 such that a total of at least five cutting surfaces are available depending upon how the cutting surface 300 is configured. In operation, two flaps 326 can be folded down on top of the main body of the apparatus 328. Once these two flap surfaces are dirty, one or both of the flaps can be unfolded to expose the underside of the flaps 330 and a secondary cutting board located under the flaps. Thus, providing the user with three new/clean surfaces 332 to use for cutting items. In alternate embodiments, the cutting board can be configured to have any known and/or convenient geometric proportions and/or to assume any number of convenient geometries such that any desired number of surfaces can be used by a user.

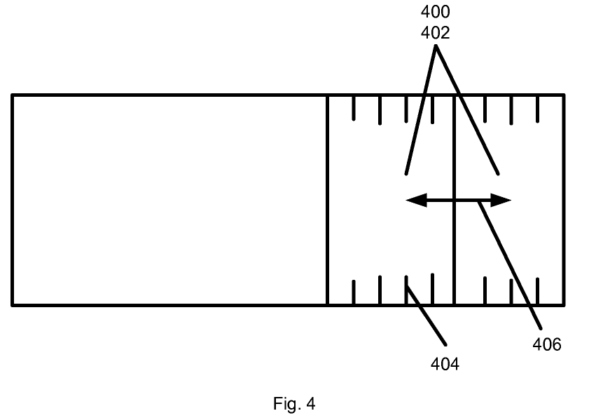

FIG. 4 depicts an alternate embodiment in which the drawer 400 and/or individual containers 402 can include a measuring arm 406 and the drawer and/or container(s) can include markings on their bases 404 and/or sides. In operation, after items are swept into the container 402 and/or drawer 400, the arm 406 can be moved to direct and/or group the contents to a specific area within the container 402 and/or drawer 400. The user can then determine the quantity of the item by comparing the measuring markings 404 on the container 402 and/or drawer 400 with the arm 406 location.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims. It should be understood that the particular embodiments described above are only illustrative of the principles of the present invention, and various modifications could be made by those skilled in the art without departing from the scope and spirit of the invention. Thus, the scope of the present invention is limited only by the claims that follow.

What is claimed is:

1. A universal cutting board system comprising:
a cutting surface; and
a drawer;
wherein said drawer is coupled with a first side of said cutting surface such that said drawer can be transitioned from an open state, a closed state and a removed state without substantial physical movement of said cutting surface.
